(19) United States
(12) Patent Application Publication
(10) Pub. No.: US 2022/0354717 A1
(43) Pub. Date: Nov. 10, 2022

(54) ASSISTED ROTATION DEVICE

(71) Applicant: Camas Robotics Booster Club, Camas, WA (US)

(72) Inventors: Bruce Joseph Whitefield, Camas, WA (US); Brian Douglas Cavill, Camas, WA (US); Taryn Elizabeth Cavill, Camas, WA (US); Brenden Alexander Cavill, Camas, WA (US); William Wayne Jolley, Camas, WA (US); Zoe Cheyenne Gondek, Camas, WA (US); Gabriel Weitian Guo, Camas, WA (US)

(21) Appl. No.: 17/731,116

(22) Filed: Apr. 27, 2022

Related U.S. Application Data
(60) Provisional application No. 63/186,681, filed on May 10, 2021.

(51) Int. Cl. A61G 3/02; A61G 5/14

(52) U.S. Cl. CPC A61G 3/02; A61G 5/14

(57) ABSTRACT

A portable rotation assist device is configured to reorient mobility impaired patients when they are moving from one location to another such as from a vehicle seat to a wheelchair. The rotation device is placed on the floor or ground between the two positions. The patient stands or can be assisted to stand on the platform on top of the device. The platform is then rotated to a second position to transfer the patient. Rotational movement and torque is provided by an onboard battery and compact motor acting through gears incorporated into the rotating platform. Choice of rotation direction and actuation of start and stop is provided by a wireless remote control. Remote control buttons are configured so they must be held down during rotation and rotation stops upon button release.

### 1. CROSS-REFERENCE TO RELATED APPLICATION

The present application claims the benefit of U.S. Provisional Patent Application No. 63/186,681, which is titled “ASSISTED ROTATION DEVICE” and was filed on May 10, 2021, the content of which is hereby incorporated by reference herein in its entirety.

### 2. FIELD OF THE INVENTION

The present invention relates to portable and powered device to assist in rotation and transfer of mobility impaired persons from one position to another, such as from a vehicle seat to a wheelchair.

### 3. DESCRIPTION OF THE PRIOR ART

Rotational transfer, such as from a bed to a wheelchair, can be a difficult and dangerous movement for a mobility impaired person. Current practice is for caregivers to lift a movement impaired patient then push or twist them to a new orientation while supporting them in a standing position. This requires an awkward shuffling choreography, each time creating a situation with risk of injury for both caregiver and patient. Assistance from a second or third caregiver may be needed for safe patient transfer.

Prior art devices use a rotatable platform on which the patent stands. Patients can be assisted to stand by a caregiver or a supporting grab bar and manually twist to a new orientation while standing on the rotating platform.

Existing manual pivot assist devices can facilitate patent transfer. A patient is first helped to stand on the disk but rotation still requires caregivers to rotate the disk by torque directed through the patient's body. Manual disk designs must compromise between static and dynamic friction so they have earned a reputation of being difficult to start rotating and then difficult to stop. Applying torque with unpredictable starts and stops creates risk of injury to caregivers and patients.

Manually rotated pivot disks are readily available but are reported to have several inherent drawbacks such as required excessive torque directed through the patents body and difficulty in stopping and starting rotation. If the necessary, turning torque is reduced then the platform too easily moves while the patient stands on it. Some manual pivot platforms are equipped with large levers used by a caregiver to reduce force on the patient but these units are expensive and large, requiring storage space and integrated wheels to roll into position.

And while powered rotation assist disks have been designed, these units are large and heavy so they are not easily transported or positioned for use. Use of a motorized pivot platform is previously disclosed (U.S. Pat. No. 7,165,276 to Hahn, et. al.) but has not found acceptance as a generally available product. It is believed that motorized pivot assist disk acceptance has been limited by lack of portability and high cost to produce. A majority of patients needing regular pivot assistance are cared for by unpaid family home caregivers. For these users, storage, portability and cost are significant considerations when deciding to use a pivot assistance device.

Prior disclosures and current commercially produced devices demonstrate a continuing need for rotational transfer assistance. Accordingly, the need exists for a rotational transfer device that overcomes these drawbacks in the prior art.

### SUMMARY OF THE INVENTION

It is an object of the present invention to utilize a battery powered motor, small electric motor compact gearing and a novel gear design to provide a lightweight, compact and portable battery powered motor driven pivot assist device that can be deployed in a wide variety of locations and has a low cost of production.

In the present invention, a design for an Assisted Rotation Device, is provided that incorporates rotational torque powered by an integrated battery and electric motor.

An additional aspect of this invention is a large disk gear incorporated around or into the rim of the rotating platform. In one embodiment shown this gear consists of multiple gear segments that are attached around the circumference of a rotatable disk to form a large diameter gear.

Another aspect of the invention is a disk mounted to a non-rotating base where the base extends past the edge of the rotating platform so that gear and edges of the rotating disk are separated by the base from direct contact with entangling or damaging materials below such as carpet fibers or dirt.

A further aspect of the invention is an enclosure for the battery and electrical components that can be sealed against water intrusion so the assisted rotation device can be safely deployed near water such as next to a pool, shower or outside a vehicle in wet weather.

Another aspect of the invention is a rotating platform separated from its base by an interleaved disk of a low friction material to reduce the motor torque and battery power needed to rotate the platform.

The rotation of the assisted rotation device presented is controlled by a remote control relay where selecting and holding down one button actuates rotation in one direction until the button is released. Selecting and holding down a different button actuates rotation in the opposite direction until that button is released.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a perspective view of an assisted rotation device embodying the principles of the present invention.

FIG. 2 is top plan view of the assisted rotation device of FIG. 1.

FIG. 3 is a front side view of the assisted rotation device of FIG. 1.

FIG. 4 is an exploded view of the drive mechanical and electrical components contained within the drive unit. For clarity of illustration, wires connecting the electrical components are omitted.

FIG. 5 is an exploded view of the top disk to base assembly showing the interleaved low friction slip disk between the top disk and base elements. FIG. 5 also provides detail on how gear segments interlock with the top disk to form a large ring gear around the circumference.

FIG. 6 is an exploded view of the top disk and gear segment assembly showing an alternate segment attachment embodiment where the interlock dovetails in the top disk also fit into recesses in the gear segments to both hold segments in place on edge of top disk and hold segments in place between the top disk and the base.

### DETAILED DESCRIPTION

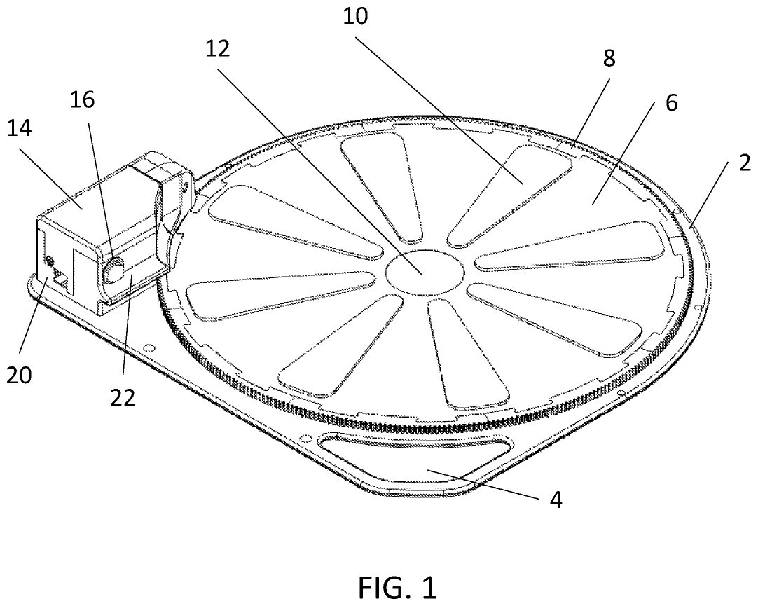

Referenced drawings show a rotational assistance device of the present invention. FIG. 1 shows an isometric view of the device. The device rests on a base 2 which has a cut out forming handle 4. The base 2 supports a drive unit housing 14 which contains drive components and electronics. The exterior of the dive unit 14 has a power switch 16 and a battery charge connection port 20.

The base 2 also supports a top disk 6 which forms the basis for a rotatable platform. The top disk 6 rotates around a center hub 12. Around the circumference of the top disk 6 are a series of gear segments 8. Gear segments 8 are sized so that a series of segments will precisely form a single large gear around the circumference of the top disk 6. By forming the gear teeth around the edge circumference of the top disk 6 a large diameter gear is created which is also very thin. This enables a flat platform suitable for a patient to step onto with minimal effort.

The top disk 6 surface has a series of wedged shaped traction tape 10 attached to provide a non-slip surface for users to stand on. The traction material can be made in various patterns and various materials such as rubber or polyurethane that are both easily cleaned and provide a non-skid surface.

The base 2 and top disk 6 are made from a low cost, machinable, low friction and easily cleaned plastic material such as HDPE. Gear segments 8 are made from a durable low cost plastic such as PLA and can be made by 3D printing, injection molding or machined. By this means a very large gear fitting the top disk 8 can be made with very low cost.

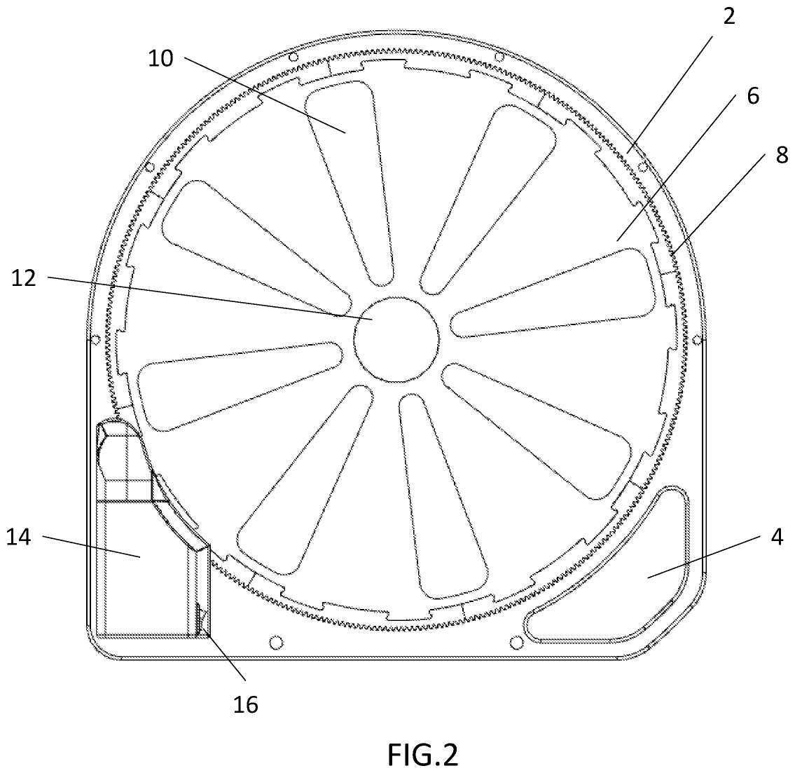

FIG. 2 shows a top plan view of the device which illustrates how the base 2 extends past the ring of gear segments 8 to separate the gear and top disk 2 from direct contact with the floor or ground. An alternate embodiment could include a cover that surrounds and covers the entire ring of gear segments 8 and attaches to the base 2.

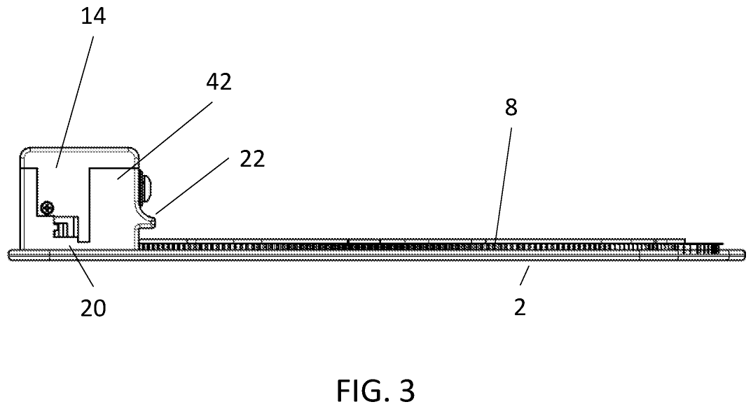

FIG. 3 shows a side front view of the device. This view helps illustrate how the drive unit 14 drive unit housing and cover 42 incorporates a pinch protector 22 extension to prevent toes, fingers or other objects from entering the drive unit 14. The drive unit cover 42 is made from water proof plastic which can be 3D Printed, machined or injection molded. Water entry points can be sealed by means of gaskets, covers or caulking.

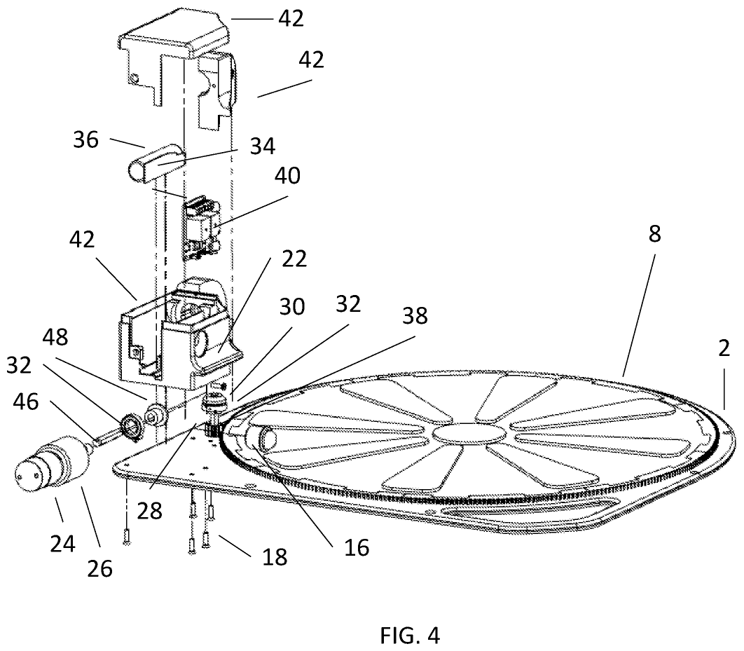

FIG. 4 is an exploded view of the drive unit 14 which shows elements of the drivetrain and control electronics. The top disk 6 is driven by a drive pinion gear 38 that is engaged with the gear teeth of the ring gear segments 8. The small pinion and large ring gear have a high mechanical advantage which reduces the torque needed to turn the rotating top disk 6. The drive pinion gear 38 is coupled to a miter gear 30 by a hexagonal pinion drive shaft 28 which is supported by a bearing 30. The bearing is held in position by the seats in the drive housing 42

The pinion drive miter gear 30 is engaged with a second miter gear 48 and bearing 32 to form a right-angle drive. In this manner the motor 24 can be mounted horizontally close to the base 2 in a low profile configuration. An alternate embodiment could omit the right-angle drive elements with a motor placed in a vertical configuration in-line with a pinion gear.

The horizontal miter gear 48 is connected by a motor drive shaft 46 to a planetary gearbox 26 and a motor 24 by a motor drive shaft 46. The motor 24 and planetary 26 are similar to those typically used in battery operated hand tools like powered screwdrivers and drills. Compact planetary gearboxes of this type typically have high gear ratios ranging from 60:1 to 120:1 in one to 3 stages. When coupled with the high gear ratio of the pinion 38 to segment gear 8 this provides sufficient mechanical advantage to rotate the top disk 6 under heavy weight loads with a small battery powered motor.

The drive unit 14 includes a battery 36 with a battery charging control board 34 which provides a connection for charging the battery 36. A remote relay board 40 provides control of rotation direction and stop and start functions via wireless connection to a remote-control unit, which is not depicted.

An alternate embodiment could include a removable battery with a separate charging station. Different voltages and capacities of batteries can be used. The planetary gear ratio can be adjusted based on the torque and speed provided by the selected battery voltage and motor to achieve a desired rotation speed. A speed control circuit could also be incorporated.

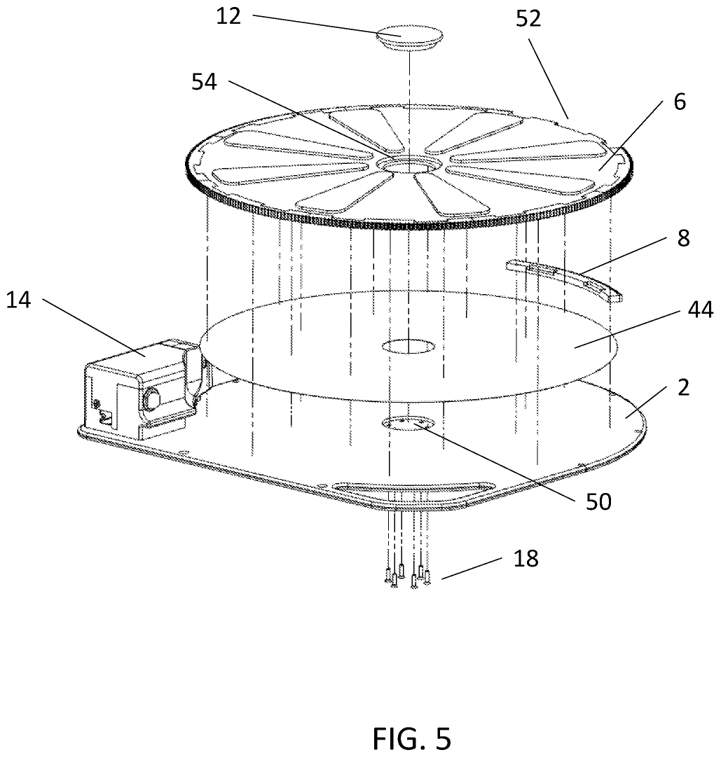

FIG. 5 shows an exploded isometric view that further illustrates elements of the rotating platform. A slip disk 44 made from a low friction material like PTFE is placed between the base 2 and the top disk 6. This serves to reduce the torque needed to rotate the platform under heavy weight loads. A hub 12 made from a low friction material fits into the top disk seat 54 and through a hole in the center of the slip disk 44 to fasten into a base pocket 50 that is cut into the base 2. The hub 12 is fastened into place with retaining screws 18 to keep disks in place and form a sturdy axle that the top disk 6 can rotate around while holding the perimeter gear segments 8 engaged with the pinion gear 38.

FIG. 5 also shows dovetail shaped notches 52 in the top disk 6. Matching extensions in the gear segments 8 are sized to fit into the notches 52. By this means the gear segments 8 are secured to the top disk 6 able to withstand drive torque exerted by the dive pinion 38.

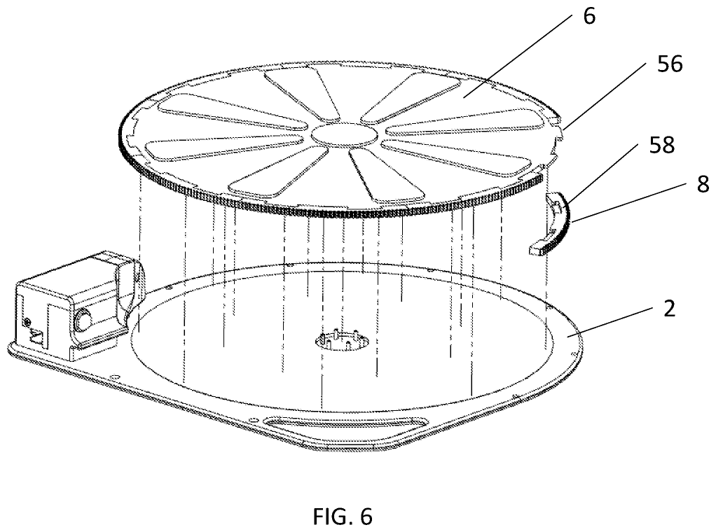

FIG. 6 further illustrates the method for attaching gear segment 8 to the Top disk 6. In this embodiment the dovetail tab 56 is cut only for a portion of the Top disk 6 thickness thus forming a lip that fits into a matching recess 58 formed in the gear segment. In this manner the dovetail tabs 58 hold the gear segment 8 onto the top disk 6 perimeter but also constrains gear segments 8 in the plane of the top disk 6 between tabs 56 and the base 2 without need for additional screws or other fasteners.

The above description is for one preferred embodiment of the invention. An assisted pivot device following the provisions of this invention can be made of various sizes, gearing and types of batteries. Alternative embodiments that may be evident to a skilled practitioner include use of a belt drive whereas gear segments 6 are reconfigured to have belt pulley teeth and a drive belt driven by belt pulley. Different sized miter gears could be used to change the drive orientation and gear ratios.

Having described and illustrated the principles of the invention in a preferred embodiment thereof, it should be apparent that the invention can be modified in arrangement and detail without departing from such principles.

What is claimed is:

1. A rotational assistance device of a type configured to rotate a mobility impaired person from one position to another, the device comprised of:
a lower base having drive components and electronics; and
an upper platform rotatably coupled to the lower base along an axis of rotation, with said drive components physically engaged with said upper platform so as rotate said platform relative to said base about the axis,
wherein said upper platform is configured to support a mobility impaired person and rotate said mobility impaired person from a first receiving position to a second exit position responsive to selective activation of the drive components and electronics.

2. A rotational assistance device comprising:
a lower base configured to rest upon and be supported by a floor;
a top disk coupled to the lower base and rotatable around a center hub;
a plurality of gear segments defined around a circumference of the top disk;
a powered drive unit mounted on the lower base outside of the circumference of the top disk and engaging with the plurality of gear segments defined around the circumference of the top disk to rotate the top disk about a vertical axis of the center hub,
wherein said top disk is configured to support a mobility impaired person and rotate said mobility impaired person about the vertical axis of the center hub from a first receiving position to a second exit position responsive to selective activation of the powered drive unit.

3. The rotational assistance device of claim 2, wherein the powered drive unit includes:
a battery;
a motor powered by the battery;
a gearbox coupled between the motor and the plurality of gear segments defined around the circumference of the top disk.

4. The rotational assistance device of claim 3, wherein the powered drive unit battery is rechargeable and a charging circuit and connector to recharge the battery are built into the rotational device.

5. The rotational assistance device of claim 2, wherein the gearbox is a planetary gearbox having a gear ratio of between approximately 60:1 and 120:1 so as to provide sufficient mechanical advantage to rotate the top disk under heavy loads with portable battery power.

6. The rotational assistance device of claim 2, wherein the powered drive unit gearbox includes a pinion drive miter gear, a second miter gear, and a bearing to form a right angle drive.

7. The rotational assistance device of claim 2, wherein the powered drive unit is activated by a remote control. in the desired direction of rotation.

8. The rotational assistance device of claim 7, wherein the powered drive unit activation requires a different button to be held down to select the desired direction of rotation.

9. The rotational assistance device of claim 7, wherein the powered drive unit activation requires the rotation selection button to be held down throughout the duration of the rotation such that so that if the button is released or the remote control is dropped the rotation will stop.

10. The rotational assistance device of claim 2 wherein the plurality of gear segments defined around the circumference of the upper platform are inserted with mating dovetail or wedge shapes mated to corresponding pockets in the upper rotating platform such that the gear segments are held horizontally in place on the said upper platform rim and sandwiched vertically between the upper platform and base platform so that the said gear segments are held in place both horizontally and vertically without additional screws, fasteners or adhesive.

11. The rotational assistance device of claim 3, wherein the battery can be removed from an electrical connection receptacle on the rotational assistance device and placed into a separate recharging station thus allowing a plurality of batteries to be used.
